(19) United States
(12) Patent Application Publication
(10) Pub. No.: US 2009/0047626 A1
(43) Pub. Date: Feb. 19, 2009

(54) TOUCH-OPERATED BRAKE RELEASE FOR A DELIVERY UNIT ARTICULATING ARM

(75) Inventors: Austin Everett Unsworth, Ft. Mill, SC (US); Jason W. Spencer, Tega Cay, SC (US); James Terry Bush, Mooresville, NC (US)

Correspondence Address: TRASK BRITT, P.O. BOX 2550, SALT LAKE CITY, UT, 84110, US

(73) Assignee: PELTON & CRANE, Charlotte, NC (US)

(21) Appl. No.: 11/837,934

(22) Filed: Aug. 13, 2007

(51) Int. Cl. A61C 3/00

(52) U.S. Cl. 433/141

(57) ABSTRACT

A hand-operated brake release may be incorporated within a medical delivery unit, such as a dental unit head, having an articulating apparatus allowing for improved ergonomic positioning of the delivery unit. The hand-operated brake release includes a sheath covering a switching element coupled to a handle in order to provide sealed brake releasing sensitive to the user's touch or grasp. A method of operating a delivery unit mounted on an articulating arm is also provided.

### FIELD OF THE INVENTION

The present invention relates to a touch-operated brake release for a delivery unit articulating arm and, more particularly, to a sealed switch located in a handle of a delivery unit for improved ambidextrous usability in an aseptic environment.

### BACKGROUND OF THE INVENTION

Enhanced medical care is promulgated by use of advanced medical equipment. The medical equipment is directed not only to improving the quality of care, but also toward procedural time savings while further reducing the anxiety or pain often times experienced by the patient. However, these desired factors may be inhibited by the need to maintain a sterile environment or are reduced by the physical limitations of the attending health care professional, both of which may increase the time to complete a given procedure. This can lead to increased anxiety to the patient or heightened pain exposure for the patient, either of which can ultimately reduce the overall quality of care. Although no logical reason for such increased levels of anxiety may exist, such anxiety is often unwanted. Other than reassurances from the dentist, the dentist's staff, and others offering encouragement, such anxiety is difficult to decrease. In some instances, the increased anxiety levels experienced by a patient in a dentist's office may also increase the blood pressure of the patient. Accordingly, it is desirable to not only improve medical equipment, but to improve the conditions under which the medical equipment is used while maintaining the sterile environment and or by reducing the resultant affects of the physician's physical limitations in working with the equipment in order to increase the quality of care.

A delivery unit is a type of medical equipment conventionally known for use in a dental office, as well as in other medical fields. The delivery unit is a structure that provides necessary tools and instruments readily available to the dentist, or the assistant, necessary for completing particular medical procedures. The delivery unit is used by the dentist under aseptic or sterile environment necessitating a particular structure for the delivery unit. For instance, the delivery unit typically encountered in the dental office is the dental unit head. The dental unit head provides an assortment of hand-held devices, such as dental air tools, cameras, syringes, vacuum accessories or ultraviolet light sources, for example, that are necessary for many dental procedures. Many of the hand-held devices are located in holsters or receptacles that are part of the outer edge of the unit head. The receptacle may include a mechanical switch to activate or deactivate the hand-held device upon insertion and removal from the unit head, thereby facilitating expedited ease of use by the dentist. The dentist will position the unit head as near as possible, with the hand-held devices located in their respective receptacles, in a location that will facilitate his repeated access to the hand-held devices, not only to improve the expedience of the procedure, but also to lessen the physiological/positional stress upon his own body. However, the positioning of the unit head with the hand-held devices in the aseptic environment is limited with the conventionally known unit heads. Accordingly, it is also desirable to improve the ease by which the unit head, with its devices, is ergonomically located in relation to the dentist.

In order to improve the positioning by a dentist, a dental unit head may be mounted upon an articulating arm that requires activation of a braking mechanism in order to maneuver the unit head to a different position. The braking mechanism is released conventionally by a mechanical switch that is located within a handle that is located on either the right side or the left side of the unit head. For example, FIG. 4 shows a conventional dental unit 10 with a side mounted handle 12 with a non-sealed button brake release 14 attached to a unit head 16 of the unit 10. Simply pulling or grabbing the handle 12 will not position the unit head 16. In order to position the unit head 16, the dentist must grab or grip the handle 12 with all but one digit and then depress the mechanical switch or non-sealed button brake release 14 with the digit, typically the right thumb, while the unit head 16 is then positioned. The opposite is true for a left side mounted handle. Undesirably, the dentist must use the same hand every time he wants to reposition the unit head for better access to or orientation of the hand-held devices on the unit head. Also, conventional mechanical switch for deactivating the braking mechanism is not sealed and invites sediment to build between moving components in the mechanical switch. The unsealed switch is difficult to clean and maintain in a septic condition. Accordingly, it would be advantageous to provide a dental unit head having a switching mechanism that is sealed for improved asepsis, and a switching mechanism that is part of the handle requiring only a touch or squeeze to operate or a handle having a switching mechanism to facilitate ambidextrous use by the dentist when positioning the unit head.

### BRIEF SUMMARY OF THE INVENTION

According to embodiments of the invention, a hand-operated brake release may be incorporated within a medical delivery unit, such as a dental unit head, having an articulating apparatus allowing for improved ergonomic positioning of the delivery unit. The hand-operated brake release may include a sheath covering a switching element coupled to a handle in order to provide sealed brake releasing sensitive to the user's touch or grasp. A brake release sensitive to the user's touch or grasp allows the user (e.g., a dentist) to selectively reposition the delivery unit with either hand during procedures providing flexibility and improved ease of use of the unit.

According to other embodiments of the invention, a hand-operated brake release provides a sheath that seals a switching element from sediment. The switching element may be used to activate a brake release that controls an articulating arm to which it is coupled. The hand-operated brake release can provide improved sterility and improved cleaning capability.

In other embodiments of the invention, there is provided a dental unit head having an assembly that includes a handle and a switching element. The switching element may be sealed for improved asepsis. The assembly may reside centrally upon the unit head or, alternatively, may be positioned elsewhere. The switching element can be pressure-activated by engagement of the assembly requiring only a touch or squeeze to simultaneously operate the assembly. Simultaneous operation of the assembly allows the user to activate the switching element while positioning the dental unit head. Simultaneous operation of the assembly facilitates ambidextrous use by the dentist when positioning the unit head and does not require specific engagement of a button switch with an additional digit. Alternatively, in other embodiments of the invention, the switching element can be a mechanical switch, a pneumatic switch, or any other suitable switch that is known in the art.

In still other embodiments of the invention, a method of operating a delivery unit mounted on an articulating arm is also provided. By engaging a sealed switch located in a handle of a delivery unit, a user may reposition the delivery unit to provide improved ambidextrous usability in an aseptic environment.

Other advantages and features of the present invention will become apparent when viewed in light of the detailed description of the various embodiments of the invention when taken in conjunction with the attached drawings and appended claims.

### BRIEF DESCRIPTION OF THE SEVERAL VIEWS OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 shows a brake release according to an embodiment of the invention;

FIG. 2 shows a partial view of a dental unit having a brake release according to another embodiment of the invention;

FIG. 3 shows a partial side view of a brake release assembly according to yet another embodiment of the invention; and

FIG. 4 shows a conventional dental unit with a side mounted handle with a non-sealed button brake release.

### DETAILED DESCRIPTION OF THE INVENTION

According to particular embodiments of the invention, a hand-operated brake release may be incorporated within a medical delivery unit, such as a dental unit head, having an articulating apparatus, allowing for improved ergonomic positioning of the delivery unit. The hand-operated brake release may include a sheath covering a switching element coupled to a handle in order to provide sealed brake releasing sensitive to the user's touch or grasp. A brake release that is sensitive to the user's touch or grasp allows the user (e.g., a dentist) to selectively reposition the delivery unit with either hand during procedures, thus providing flexibility and improved ease of use of the unit.

According to other embodiments of the invention, a hand-operated brake release can provide a sheath that seals a switching element from sediment. The switching element may be used to activate a brake release that controls an articulating arm to which it is coupled. The hand-operated brake release can provide improved sterility and improved cleaning capability.

In other embodiments of the invention, a dental unit head includes an assembly that has a handle and a switching element. The switching element may be sealed for improved asepsis. The assembly may reside centrally upon the unit head or may, alternatively, be positioned elsewhere. The switching element is pressure-activated by engagement of the assembly requiring only a touch or squeeze to simultaneously operate the assembly. Simultaneous operation of the assembly allows the user to activate the switching element while positioning the dental unit head. Simultaneous operation of the assembly facilitates ambidextrous use by the dentist when positioning the unit head while not requiring specific engagement of a button switch with an additional digit, particularly the thumb.

In still other embodiments of the invention, a method of operating a delivery unit mounted on an articulating arm is also provided. By engaging a sealed switch located in a handle of a delivery unit, a user may reposition the delivery unit providing improved ambidextrous usability in an aseptic environment.

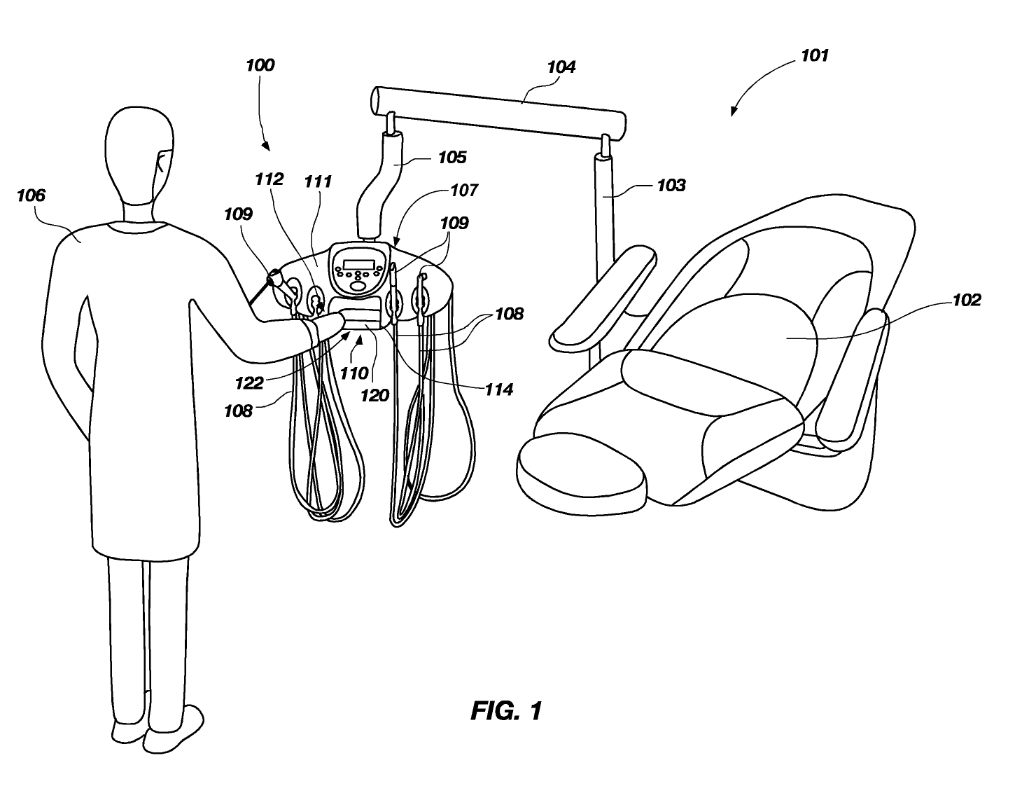

FIG. 1 shows a brake release 110 according to an embodiment of the invention. The brake release or assembly 110 is included in a delivery unit 100 to facilitate movement and positioning of the delivery unit 100. The delivery unit 100 is part of a dental system 101 that may include a base 103 mounted to an articulating arm 104 with and to pivot on a swing 105. The base 103 may be mounted to a dental or patient chair 102. The delivery unit 100 is coupled to the swing 105, allowing the delivery unit 100 to be conveniently positioned by a dentist or assistant 106. The delivery unit 100 provides a control mechanism 107 to control, support and supply multiple supply conduits 108 that are coupled to the dental hand-pieces or hand-held devices 109 supported by a receptacle in a unit head 111 of the delivery unit 100. The supply conduits 108 may provide, for example, the supply of electricity, vacuum, water, air and/or light, to the hand-held devices 109 by way of the delivery unit 100 and is generally well understood by persons of skill in the art. Typically, conduits 108 may terminate in quick release ends to which the hand-held devices 109 are attached. Further, the control mechanism 107, the supply conduits 108, and the hand-held devices 109 are generally understood by a person of skill in the dental art and further description is not required for a proper understanding and appreciation of the invention herein described.

In order to provide convenient and easy access to different hand-held devices during any given procedure, it is desirable to allow the unit head 111 of the delivery unit 100 to be positioned and repositioned from time to time into different positions. Positioning the delivery unit 100 may be accomplished by deactivating a normally pressurized brake (not shown) that is part of the dental system 101 or is operatively coupled to the articulating components 103, 104, 105. When the normally pressurized brake is deactivated, the articulating components (i.e., the base 103, the articulating arm 104 or the swing 105, including any combination thereof) are allowed to move freely about their joints (not shown) in order to reposition the delivery unit 100. It is recognized that articulating arms and brake systems for use with dental units are conventionally known by persons of skill in the art and further elaboration is not required for a proper and comprehensive understanding of the invention herein present.

It is recognized that the “unit head” 111 is a structure for receiving medical instruments. While the unit head 111 is included as part of the delivery unit 100 in this embodiment, it may also be a separate structure. Optionally, the unit head 111 may include, in addition to providing support for the hand-held devices 109, a flat or instrument surface for receiving other tools and medical instruments.

While the delivery unit 100, as described thus far, is generally known within the dental industry, it is also recognized that the delivery unit 100 may be, for example, a stand alone or self-contained device that is mounted within a cabinet, upon a medical cart, or as part of other medical equipment. The brake release 110 of the invention can be adapted for use in a delivery unit that is coupled to or part of an articulating apparatus. Further, the delivery unit may also be suitable for use in other medical fields and need not necessarily be limited to the dental field.

The brake release 110 in this embodiment is centrally located in the delivery unit 100 to facilitating minimal amount of movement by both right and left handed individuals when repositioning the delivery unit 100. However, it is recognized that the brake release 110 may be included conveniently elsewhere on the unit head or delivery unit as desired.

The brake release 110 can include a sheath 120 coupled to the unit head 111 of the delivery unit 100 at ends 112 and 114 and can include a gripping portion 122. The brake release 110 can further include a handle (see item 326 of FIG. 3, for example), coupled to the unit head 111 at ends 112 and 114, supports a switching element (see item 324 of FIG. 3, for example), both coupled within the sheath 120, that allows the switching element to be “energized” or activated when a user touches or grips the gripping portion 122. “Energizing” or activating the switching element releases the brake (not shown) allowing the unit head 111 of the delivery unit 100 to be repositioned. It is also recognized that the switching element may deactivate the brake when the sheath 120 is engaged by a user's hand.

The sheath 120 of the current embodiment can include a substantially cylindrical body having connection ends 112 and 114 and a hollow midsection, allowing the sheath 120 to completely enclose the handle and the switching element when coupled to the unit head 111. The sheath 120 can be a flexible insert being made out of rubber. It is recognized that sheath 120 may be made from any other shape and material suitable for use with the invention. By way of example, the sheath may have a shape conforming to or matched with the attached handle and switching element. Also, the material of the sheath 120 can be made of any pliable material such that the sheath will allow a user to contact the gripping portion 122 of the brake release 110 in order to “activate” the brake, while “deactivating” the brake when the user releases contact from the material. Specifically, the sheath 120 may be any pliable material such as, for example, leather, rubber, natural material, synthetic and elastomer materials. The pliable material may be selected from a group of materials facilitating aseptic conditions when cleaned.

Optionally, the sheath 120 aseptically shields the switching element that is operatively coupled to the handle. While the sheath 120 is coupled to the unit head 111 at ends 112, 114, it is recognized that the sheath may be coupled to the unit head 111 at a single end while shielding a switching element operatively supported by a handle.

The switching element in this particular embodiment is provided as a pressure-activated switch. Also, the unit head 111 of the delivery unit 100 of this embodiment is a dental delivery unit head for receiving at least one hand-held device 109 used during dental procedures.

It is noted that the gripping portion 122 of the delivery unit 100 can encompass the same general area or portion of the unit head 111, the sheath 120, or the handle, without limitation. In this regard the gripping portion 122 is used to generally describe the operable contact portion or area in which a user's hand provides gripping or touching contact for “activating” the brake release 110.

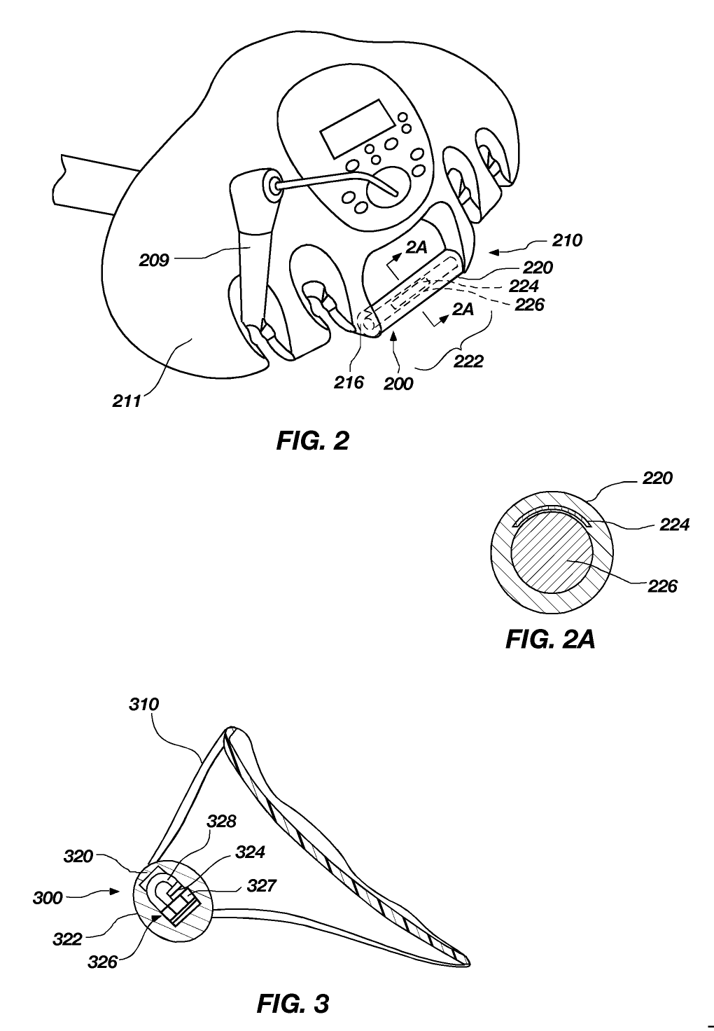

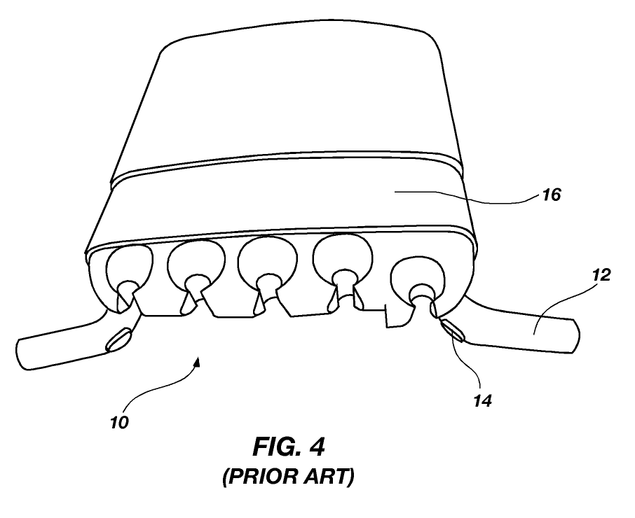

FIG. 2 shows a partial view of a dental unit 210 having a brake release 200 according to another embodiment of the invention. The brake release 200 is coupled to the dental unit 210 at a centralized frontal location 216 in order to facilitate ambidextrous use of both hands when accessing medical tools 209 from the unit head 211. As shown in FIGS. 2 and 2A, the brake release 200 can include, for example, a pliable sheath or insert 220 made from natural rubber, a switching element 224 and a support handle or structure 226. The structure 226 may rigidly couple to the frontal location 216 and operatively support the insert 220 and the switching element 224. As indicated herein, the insert 220 can be coupled to the centralized frontal location 216 in order to shield the structure 226 and the switching element 224 by providing a barrier from sediment.

The switching element 224 can be “activated” by gripping the gripping portion 222 of the brake release 200. The switching element 224 in this particular embodiment is shown as an inductive-type sensor. Further elaboration of the inductive sensor is not required as it is generally understood by a person having skill in the art of sensors. The sensor can be supported by the structure 226 and flexibly coupled to or within the material of the insert 220 in order to change the electrical state of the sensor when a user applies touch or grip to the insert 220. The change of electrical state provides the activation or deactivation for the brake release 200.

It is understood that any other suitable sensor known in the art can be used with the present invention. For example, an inductive-field sensor reactively coupled to the insert 220 may be utilized.

FIG. 3 shows a partial side view of a brake release assembly 300 according to yet another embodiment of the invention. The brake release assembly 300 can be coupled to a unit 310 and can include a handle 326, a pressure or mechanical switch 324 and a flexible cover 320 covering and shielding the handle 326 and the switch 324. The handle 326 can include an internal support member 327 and a compression member 328. The compression member 328 may be retained by the support member 327 while providing relative movement therebetween. The support member 327 can be securely coupled to the unit 310. The switch 324 can be compressively retained between the support member 327 and the compression member 328, such that the compression member 328 “activates” the switch 324 when a user touches or grips the flexible cover 320. Further, when a user releases the flexible cover 320, the switch 324 can provide a restoring force to the compression member 328, allowing the switch to “deactivate.” In terms of the present embodiment, the words “activate” and “deactivate” refer to the contacts of the switch being in either an open or closed position, without limitation. Generally, the switch 324 is “activated” when a user makes, in this embodiment of the invention, squeezing contact with a gripping portion 322 of the brake release assembly 300.

In particular embodiments of the invention, the user may simultaneously release a pressurized brake of an articulating arm and position a medical unit or unit head by a single grasp or touch of a brake release of the invention. A brake release can eliminate the need for a conventional push button while advantageously providing an improved septic environment.

While the terms “activate” or “deactivate” have been selectively used for the various components of the several embodiments of the invention, it is to be understood that these terms may be used interchangeably according to the logic scheme required in order to operate and position a dental unit, delivery unit, or unit head being coupled to an articulating structure or articulating arm.

While various types of switching elements have been provided in the embodiments of the invention, a person of skill in the art will comprehend and be suitably capable of wiring or connecting the switching element operatively to a normally pressurized brake.

While particular embodiments of the invention have been shown and described, numerous variations and alternate embodiments will occur to those skilled in the art. Accordingly, it is intended that the invention be limited in terms of the appended claims.

1. A hand-operated brake release for an articulating apparatus comprising:
a unit head;
a handle coupled to the unit head, the handle comprising a gripping portion;
a sheath that substantially covers the handle; and
a switching element for controlling a brake, the switching element being coupled to the gripping portion of the handle, the switching element operatively coupled to and substantially shielded by the sheath.

2. The hand-operated brake release of claim 1, wherein the unit head is a dental delivery unit.

3. The hand-operated brake release of claim 1, wherein the sheath is made from a pliable material.

4. The hand-operated brake release of claim 3, wherein the sheath is made from flexible rubber.

5. The hand-operated brake release of claim 1, wherein the handle is coupled to a centralized front location of the unit head.

6. The hand-operated brake release of claim 1, wherein the sheath includes a gripping surface and the switching element is deactivated upon contact with the gripping surface.

7. The hand-operated brake release of claim 6, wherein the switching element is operatively coupled within the gripping surface of the sheath.

8. The hand-operated brake release of claim 1, wherein the switching element is an inductive type sensor.

9. The hand-operated brake release of claim 1, wherein the switching element is selected from the group consisting of a mechanical switch, a pneumatic switch, and a pressure-activated switch.

10. A delivery unit comprising:
a brake;
an articulating arm including at least one arm piece coupled by at least one joint, the joint articulately secured to the arm piece by the brake;
a unit head supported by the articulating arm;
a handle coupled to the unit head, the handle comprising a gripping portion;
a sheath that substantially covers the handle; and
a switching element for controlling a brake, the switching element being coupled to the gripping portion of the handle, the switching element operatively coupled to and substantially shielded by the sheath.

11. The delivery unit of claim 10, wherein the unit head is a dental delivery unit head including at least one device receptacle.

12. The delivery unit of claim 11, further comprising at least one hand-held device, the at least one hand-held device configured to be received by the device receptacle.

13. The delivery unit of claim 10, wherein the switching element deactivates the brake when the sheath is engaged by a user's hand.

14. The delivery unit of claim 10, wherein the sheath is a flexible rubber insert.

15. The delivery unit of claim 10, wherein the handle is coupled to a centralized front location of the unit head.

16. The delivery unit of claim 10, wherein the switching element is selected from the group consisting of a pressure-activated switch, a mechanical switch, and a pneumatic switch.

17. A method of operating a delivery unit mounted on an articulating arm comprising:
providing a unit head supported by an articulating arm secured by a brake, the unit head comprising a sheath substantially enclosing a handle coupled to the unit head;
providing a switching element, the switching element operatively coupled to the handle and substantially shielded by the sheath; and
engaging the sheath by a user's touch to activate the switching element.

18. The method of claim 17, further comprising deactivating a pressurized brake, and repositioning the unit head upon deactivation.

19. The method of claim 18, wherein deactivating and repositioning are simultaneously accomplished by engaging the handle.

20. The method of claim 17, wherein providing a switching element comprises providing a mechanical switch, a pneumatic switch, or a pressure-activated switch.
